(19) United States
(12) Patent Application Publication
(10) Pub. No.: US 2013/0281026 A1
(43) Pub. Date: Oct. 24, 2013

(54) DEVICE COGNITION APPARATUS AND METHOD FOR COGNIZING DEVICE USING THE SAME

(71) Applicants: YOUNG-HOON KIM, Daejeon (KR); Seon-Ae KIM, Chungcheongbuk-do (KR); Tae Joong KIM, Gyeonggi-do (KR)

(72) Inventors: YOUNG-HOON KIM, Daejeon (KR); Seon-Ae KIM, Chungcheongbuk-do (KR); Tae Joong KIM, Gyeonggi-do (KR)

(73) Assignee: Electronics and Telecommunications Research Institute, Daejeon (KR)

(21) Appl. No.: 13/616,911

(22) Filed: Sep. 14, 2012

(30) Foreign Application Priority Data
Apr. 18, 2012 (KR) 10-2012-0040293

(51) Int. Cl. H04B 7/26; H04B 17/00

(52) U.S. Cl. 455/67.11

(57) ABSTRACT

The inventive concept directly relates to device cognition apparatus. The device cognition apparatus according to the inventive concept may include a wireless part forming a main beam and side beams, a transmission signal processing part pointing the main beam at a peripheral device for establishing a communication link, a reception signal processing part receiving reception signal intensities respectively corresponding to the main beam and the side beams from each of a plurality of peripheral devices, and a controller calculating signal differences between the main beam and the side beams based on the received reception signal intensities and selecting the peripheral device for establishing the communication link from the plurality of peripheral devices by the result of the calculation.

### CROSS-REFERENCE TO RELATED APPLICATIONS

This U.S. non-provisional patent application claims priority under 35 U.S.C. §119 to Korean Patent Application No. 10-2012-0040293, filed on Apr. 18, 2012, the entirety of which is incorporated by reference herein.

### BACKGROUND

The inventive concept relates to a communication system and, more particularly, to a device cognition apparatus cognizing a device corresponding to a target of communication by forming a beam and a method for cognizing a device using the same.

Communication systems may include wireless integrated communication systems such as Bluetooth or WiFi-direct. The wireless integrated communication systems may search all devices within coverage of an electric wave for communication between two devices and then generate a list for selection of a user. The user may select a desired device from the list provided in a user's device (i.e., a main device) and then establish a communication link.

However, the searching all devices may need a long time. Additionally, as the number of peripheral devices around the main device increases, the time for searching the devices may more increase. Moreover, if the number of the devices in the list increases, the selection by the user from the list may be inconvenient and the time for selecting the desired device in the list may increase. Furthermore, if the user does not know a name of the desired device for establishing the communication link according to application service, the communication link establishment between the devices may not be carried out.

For resolving the problems described above, peripheral devices may be searched using a short range communication technique. The main device may search the peripheral devices by near field communication (NFC) or infrared data association (IrDA), and then may obtain information for Bluetooth connection from the searched device. The main device may use the obtained information so as to be directly connected to the peripheral device through Bluetooth communication. In other words, it is possible to search peripheral devices by two or more short range communication techniques for establishing the communication link between the devices. However, the short range communication technique may be limited to a communication distance between the devices. In other words, it is difficult to create a sufficient distance for searching between the peripheral devices.

### SUMMARY

Embodiments of the inventive concept may provide device cognition apparatus capable of reducing a time necessary to select a device for establishing a communication link and methods for cognizing a device using the same.

Embodiments of the inventive concept may also provide device cognition apparatus capable of creating a sufficient distance for selecting peripheral devices and methods for cognizing a device using the same.

In one aspect, a device cognition apparatus may include: a wireless part forming a main beam and side beams; a transmission signal processing part pointing the main beam at a peripheral device for establishing a communication link; a reception signal processing part receiving reception signal intensities respectively corresponding to the main beam and the side beams from each of a plurality of peripheral devices; and a controller calculating signal differences between the main beam and the side beams based on the received reception signal intensities and selecting the peripheral device for establishing the communication link from the plurality of peripheral devices by the result of the calculation.

In some embodiments, the reception signal processing part may receive peripheral device identifiers for respectively cognizing the plurality of peripheral devices from the plurality of peripheral device.

In other embodiments, the transmission signal processing part may control the wireless part in order that a single including an identifier information of the peripheral device for establishing the communication link is transmitted through the main beam.

In still other embodiments, the controller may include: a signal intensity calculation part calculating signal intensity differences between the main beam and the side beams by calculating the signal differences; a device cognition part cognizing the peripheral device having a minimum difference between the calculated signal intensity differences as the peripheral device for establishing the communication link; and a link establishment part establishing the communication link with the cognized peripheral device through paging.

In even other embodiments, the controller may exclude a peripheral device of which the signal intensity received through the reception signal processing part is less than a predetermined critical value, from selecting the peripheral device for establishing the communication link.

In yet other embodiments, the controller may control the transmission signal processing part so that the transmission signal processing part transmits a paging signal to establish the communication link by paging of the selected peripheral device.

In yet still other embodiments, the wireless part may include an arrangement antenna for generating the main beam and the side beams.

In yet still other embodiments, the transmission signal processing part may transmit a signal including a cognition device identifier of the peripheral device for establishing the communication link when the wireless part forms the main beam and the side beams.

In another aspect, a method for cognizing a device using a device cognition apparatus may include: forming a main beam and side beams; receiving reception signal intensities respectively corresponding to the main beam and the side beams from each of peripheral devices; selecting a peripheral device having the minimum difference between signal intensity differences between the main beam and the side beams; and establishing a communication link with the selected peripheral device through paging.

In some embodiments, forming the main beam and the side beams may include: forming the main beam and the side beams toward the peripheral device desiring the communication link.

In other embodiments, the side beams may be disposed at a left side and a right side of the main beam, respectively.

In still other embodiments, selecting the peripheral device may include: calculating a first signal intensity difference between the main beam and the left side beam and a second signal intensity difference between the main beam and the right side beam of each of the peripheral devices; calculating an absolute difference value between the first signal intensity difference and the second signal intensity difference of each of the peripheral devices; and selecting the peripheral device having the minimum absolute difference value from the peripheral devices.

### BRIEF DESCRIPTION OF THE DRAWINGS

The inventive concept will become more apparent in view of the attached drawings and accompanying detailed description.

FIG. 1 shows a device cognition system including a device cognition apparatus cognizing a peripheral device according to embodiments of the inventive concept;

FIG. 2 is a schematic block diagram illustrating a device cognition apparatus according to embodiments of the inventive concept;

FIG. 3 is a flow chart illustrating an operation method of a communication link establishment apparatus illustrated in FIG. 2;

FIG. 4 is a schematic block diagram illustrating a peripheral device of a device cognition apparatus; and

FIG. 5 is a flow chart illustrating an operation method of the peripheral device illustrated in FIG. 4.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

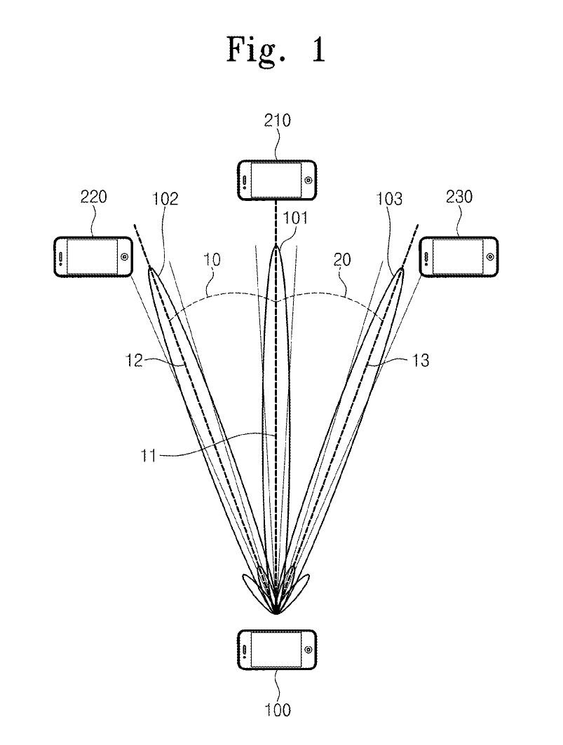

FIG. 1 shows a device cognition system including a device cognition apparatus cognizing a peripheral device according to embodiments of the inventive concept.

Referring to FIG. 1, a device cognition system includes a device cognition apparatus 100 for establishing a communication link and a plurality of peripheral devices 210, 220, and 230 located around the device cognition apparatus 100.

The device cognition apparatus 100 may be a device desiring to establish a communication link with one of the peripheral devices 210, 220, and 230. The device cognition apparatus 100 may be a user's device. The device cognition apparatus 100 may be a communication main device in a communication link establishment system. The device cognition apparatus 100 forms a main beam 101 toward a peripheral device 220 desiring to establish the communication link among the peripheral devices 210, 220, and 230 located within a visibility range in which the communication link is possible. To achieve this, the user may point an antenna arrays of the device cognition apparatus 100 toward the peripheral device 220 desiring to establish the communication link. Additionally, the device cognition apparatus 100 may form side beams 102 and 103 around the main beam 101. A first side beam 102 may be located at a left side of the main beam 101 and a second side beam 103 may be located at a right side of the main beam 101.

The main beam 101 may be formed based on a center line 11 located at a center of the main beam 101. The first side beam 102 may be formed based on a center line 12 located on a center of the first side beam 102. The second side beam 103 may be formed based on a center line 13 located on a center of the second side beam 103.

The first side beam 102 may be located at the left side of the main beam 101 by an angle 10 between the center line 11 of the main beam 101 and the center line 12 of the first side beam 102. The second side beam 103 may be located at the right side of the main beam 101 by an angle 20 between the center line 11 of the main beam 101 and the center line 13 of the second side beam 103. Here, the angles 10 and 20 may have the same value as each other or have values different form each other, respectively.

The device cognition apparatus 100 according the inventive concept may form one main beam 101 and two or more side beams 102 and 103 around the main beam 101.

Here, the device cognition apparatus 100 may be a user's device or a main device cognizing a device, and the peripheral devices 210, 220, and 230 may be target devices for cognition.

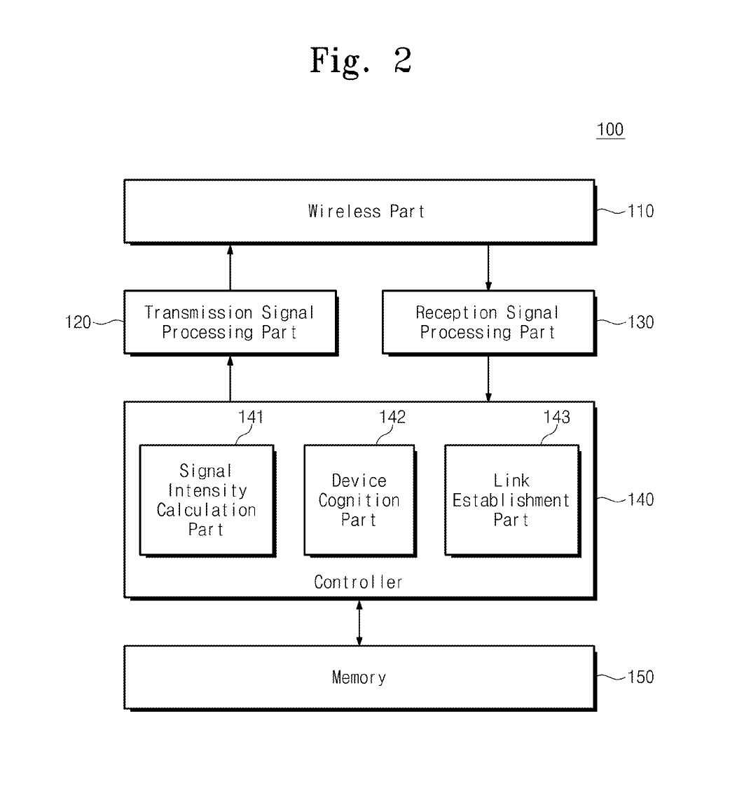

FIG. 2 is a schematic block diagram illustrating a device cognition apparatus according to embodiments of the inventive concept.

Referring to FIG. 2, the device cognition apparatus 100 includes a wireless part 110, a transmission signal processing part 120, a reception signal processing part 130, a controller 140, and a memory 160.

The wireless part 110 may include an antenna for beam formation. For example, the wireless part 110 may include an arrangement antenna or a beam formation antenna. The wireless part 110 may transmit or receive a signal through the antenna. The wireless part 110 may transmit a signal inputted from the transmission signal processing part 120 through the antenna. And the wireless part 110 may output a reception signal received through the antenna to the reception signal processing part 130.

On the other hand, the wireless part 110 may perform the beam formation for transmitting a signal according to controlling of the transmission signal processing part 120. At this time, the wireless part 110 may point the center line 11 of the main beam 101 toward the peripheral device 220 desiring communication according to controlling of the transmission signal processing part 120.

The transmission signal processing part 120 may perform a signal processing for transmitting a signal received from the controller 140 through the wireless part 110. The transmission signal processing part 120 may be inputted with coefficients and parameters necessary to the beam formation from the controller 140. The transmission signal processing part 120 may be inputted with a cognition device identifier corresponding to a temporary identifier of the device cognition apparatus which is generated by the controller 140. At this time, the transmission signal processing part 120 may control the wireless part 110 to form the beams using the coefficients and the parameters necessary to the beam formation. Additionally, the transmission signal processing part 120 may add the cognition device identifier to the transmission signal transmitted through the beam formation and then output the transmission signal including the cognition device identifier to the wireless part 110. The transmission signal processing part 120 may receive a signal for paging to the cognized peripheral devices from the controller 110, and then the transmission signal processing part 120 may process the received signal so as to provide the processed signal to the wireless part 110.

The reception signal processing part 130 may process a reception signal received from the wireless part 110. Here, the reception signal is a signal transmitted from each of the peripheral devices and includes a peripheral device identifier corresponding to a temporary identifier of each of the peripheral devices. Additionally, the reception signal further includes reception signal intensities which respectively correspond to three beams (i.e., the main beam 101 and the side beams 102 and 103) of each of the peripheral devices. The reception signal processing part 130 may output the peripheral device identifiers and the reception signal intensities to the controller 140 through demodulation. Furthermore, if the reception signal processing part 130 receives the signal for paging from the cognized peripheral device through the wireless part 110, the reception signal processing part 130 provides the received signal to the controller 140.

If the device desiring communication is determined, the controller 140 generates the coefficients and the parameters necessary to the beam formation for forming the beams toward the corresponding device. The controller 140 outputs the coefficients and the parameters necessary to the beam formation to the transmission signal processing part 120. Additionally, the controller 140 generates the cognition device identifier for distinguishing of the device cognition apparatus 100 and for transmission of a signal intensity of the device cognition apparatus 100. The controller 140 outputs the cognition device identifier to the transmission signal processing part 120 for transmitting the cognition device identifier through the beam formation.

The controller 140 may include a signal intensity calculation part 141 for calculating the signal intensity, a device cognition part 142 for cognizing a device, and a link establishment part 143 establishing the communication link.

The signal intensity calculation part 141 receives the peripheral device identifiers and the reception signal intensities detected at the peripheral device from the reception signal processing part 130. The signal intensities of the peripheral devices which are received into the signal intensity calculation part 141 may be signal intensities with respect to the beams. The signal intensity calculation part 141 calculates a first signal intensity difference DIF1 between the main beam 101 and the first side beam 102 and a second signal intensity difference DIF2 between the main beam 101 and the second side beam 103. Additionally, the signal intensity calculation part 141 calculates an absolute difference value ABS between the calculated signal intensity differences. For example, the absolute difference value ABS calculated by the signal intensity calculation part 141 may be represented as the following equation 1.

ABS=|DIF1−DIF2| or ABS=DIF2−DIF1| [Equation 1]

As described in the equation 1, the absolute difference value ABS may be an absolute value of a value obtained by subtracting the second signal intensity difference DIF2 from the first signal intensity difference DIF1, or an absolute value of a value obtained by subtracting the first signal intensity difference DIF1 from the second signal intensity difference DIF2.

The signal intensity calculation part 141 may store the absolute difference values ABS of all peripheral devices with the peripheral device identifiers of the corresponding peripheral devices and the signal intensity of the main beam 101 in the memory 150.

On the other hand, before calculating the signal intensity differences DIF1 and DIF2, the signal intensity calculation part 141 may not calculate signal intensity differences of a peripheral device having the main beam 101 of which the reception signal intensity is less than predetermined reference reception signal intensity. Thus, the peripheral devices relatively located far away from the main bean 101 may be excluded from the signal intensity difference calculation, such that the calculation amount of the signal intensity calculation part 141 may be reduced.

The device cognition part 142 may arrange the peripheral devices in order of size of the reception signal intensity of the main beam 101 stored in the memory 150 from the largest to the smallest. At this time, the device cognition part 142 may select the predetermined number of the peripheral devices in order from the peripheral device having the largest reception signal intensity of the main beam 101. The device cognition part 142 may cognize the peripheral device having the minimum absolute difference value ABS of the list of the selected devices as a target device. For example, the peripheral device 210 located in a direction of the main beam 101 may be cognized as the communication target device. The device cognition part 142 may manage the list of the selected devices through the memory 150.

If the device cognition part 142 cognizes the communication target device, the device cognition part 142 may output information of the cognized communication device to the user through a display part (not shown). Additionally, the device cognition part 142 may confirm the cognized device through a user input unit (not shown), for example, a touch pad, a keypad, and a button.

For paging the cognized peripheral device, the link establishment part 143 transmits the peripheral device identifier to an upper layer, and the upper layer controls the paging operation using the peripheral device identifier. The link establishment part 143 generates a request signal for paging and then outputs the signal to the transmission signal processing part 120. When the link establishment part 143 receives a response signal for paging from the reception signal processing part 130, the ling establishment part 143 may perform the paging operation. The link establishment part 143 may establish the communication link with the peripheral device through the paging.

As described above, the device cognition apparatus 100 according to the inventive concept cognizes a desired device through the beam formation, such than a distance for searching of the peripheral devices may increase. Additionally, the device cognition apparatus 100 cognizes the peripheral device by calculating the signal intensities of the beams, so that a required time for selecting the desired peripheral device may be reduced.

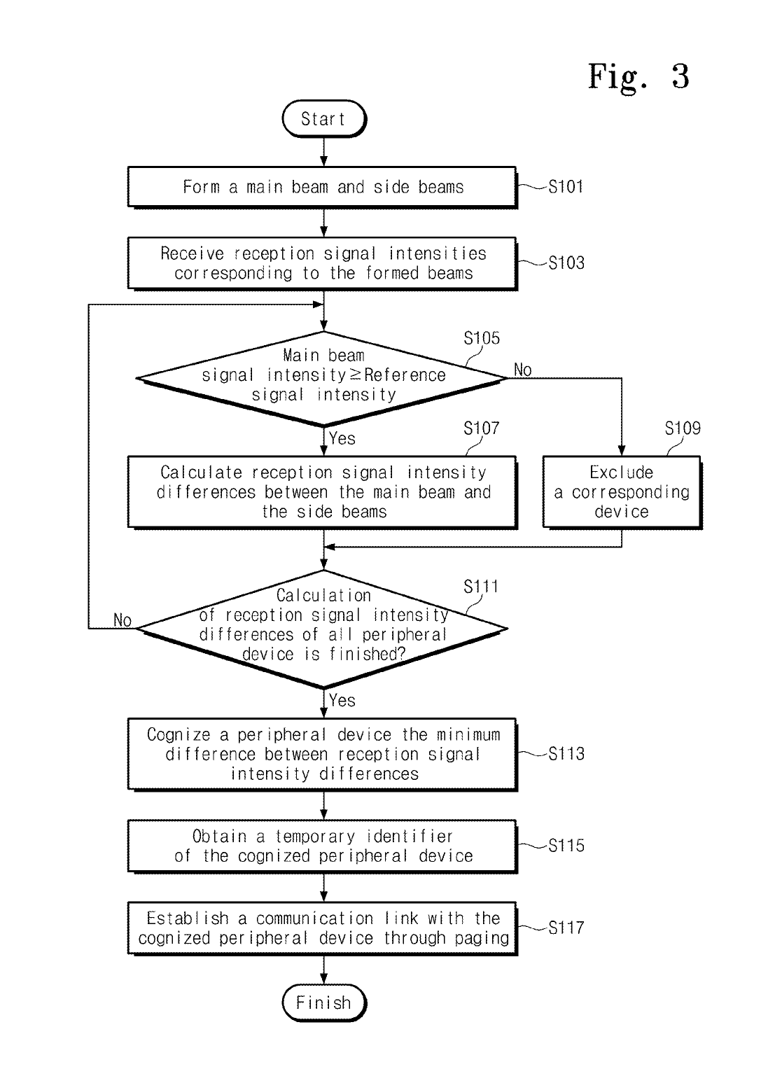

FIG. 3 is a flow chart illustrating an operation method of a communication link establishment apparatus illustrated in FIG. 2.

Referring to FIG. 3, the wireless part 110 forms the main beam 101 and the side beams 102 and 103 toward the desired peripheral device by controlling of the transmission signal processing part 120 (S101).

The reception signal processing part 130 receives reception signal intensities corresponding to the formed beams 101, 102, and 103 from the peripheral devices through the wireless part 110 (S103). The reception signal processing part 130 processes the received reception signal intensities and then outputs the processed reception signals intensities to the controller 140.

The signal intensity calculation part 141 judges whether the main beam signal intensity of the peripheral device is equal to or greater than the reference signal intensity or not (S105). If the main beam signal intensity of the peripheral device is equal to or greater than the reference signal intensity, the operation proceeds to a step S107.

The signal intensity calculation part 141 calculates the reception signal differences between the main beam and the side beams (S107). In other words, the signal intensity calculation part 141 calculates the first signal intensity difference DIF1 (i.e., the difference between the signal intensities of the main beam 101 and the first side beam 102) and the second signal intensity difference DIF2 (i.e., the difference between the signal intensities of the main beam 101 and the second side beam 103). And then the operation proceeds to a step S111. At this time, the signal intensity calculation part 141 may store the calculated signal intensity differences of the peripheral device in the memory 150.

If the signal intensity of the main beam 101 of the peripheral device is smaller than the reference signal intensity as the result of the step S105, the signal intensity calculation part 141 proceeds to a step S109. The signal intensity calculation part 141 excludes the device having the main beam signal intensity under the reference signal intensity from the peripheral devices for cognition and then proceeds to the step S111.

The signal intensity calculation part 141 confirms whether the calculation of the signal intensity differences of all peripheral devices is finished or not (S111). If the calculation of the signal intensity differences of all peripheral devices is not finished, the signal intensity calculation part 141 proceeds to the step S105.

If the calculation of the signal intensity differences of all peripheral devices is finished, the signal intensity calculation part 141 proceeds to a step S113.

The device cognition part 142 selects the peripheral device having the minimum difference between the measured reception signal intensities of the peripheral devices (S113). The device cognition part 142 selects the peripheral device having the minimum absolute difference value ABS.

The device cognition part 142 obtains the peripheral device identifier (i.e., the temporary identifier) of the cognized peripheral device for paging (S115). At this time, the device cognition part 142 may provide information of the cognized peripheral device to the user and receive confirmation of the cognized peripheral device.

The link establishment part 142 establishes the communication link with the cognized peripheral device through the paging (S117). For example, the link establishment part 143 may transmit a paging request signal to the cognized peripheral device and perform the paging operation by receiving a paging response signal. If the paging is successfully performed, the link establishment part 142 may establish the communication link with the cognized peripheral device.

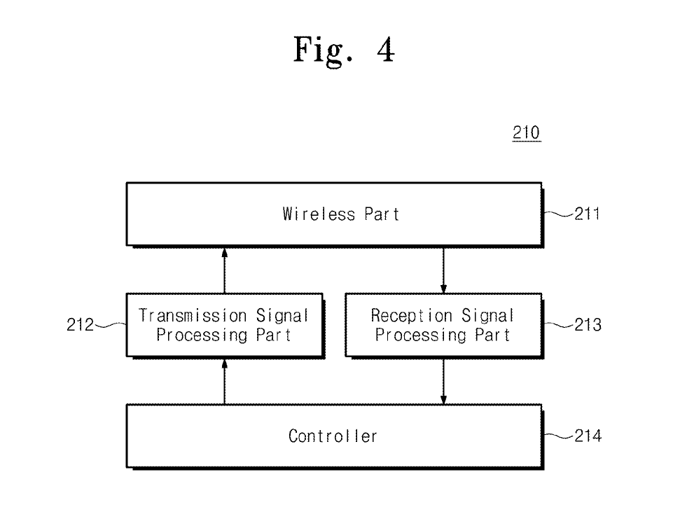

FIG. 4 is a schematic block diagram illustrating a peripheral device of a device cognition apparatus.

Referring to FIG. 4, the peripheral device 210 includes a wireless part 211, a transmission signal processing part 212, a reception signal processing part 213, and a controller 214.

The wireless part 211 includes an antenna. The wireless part 211 may transmit or receive a signal through the antenna. The wireless part 211 transmits a signal inputted from the transmission signal processing part 212 through the antenna and outputs a reception signal received through the antenna to the reception signal processing part 213.

The transmission signal processing part 212 performs a signal processing for transmitting a signal received from the controller 214 through the wireless part 211. The transmission signal processing part 212 is inputted with a peripheral device identifier corresponding to a temporary identifier of a peripheral device which is generated by the controller 214. The transmission signal processing part 212 is inputted with reception signal intensities of formed beams. Additionally, the transmission signal processing part 212 adds the peripheral device identifier and the reception signal intensities to the transmission signal and then outputs the transmission signal including the peripheral device identifier and the reception signal intensities to the wireless part 211.

The reception signal processing part 213 processes the reception signal received from the wireless part 211. The reception signal includes the cognition device identifier of the device cognition apparatus. The reception signal processing part 213 outputs the reception signal to the controller 214 through demodulation of the cognition device identifier. The reception signal processing part 213 measures reception signal intensities which correspond to three beams (i.e., the main beam 101 and the side beams 102 and 103), respectively. The reception signal processing part 213 outputs the measured reception signal intensities to the controller 214.

If the controller 214 receives the cognition device identifier and the reception signal intensities from the reception signal processing part 213, the controller 214 outputs the peripheral device identifier and the reception signal intensities to the transmission signal processing part 212.

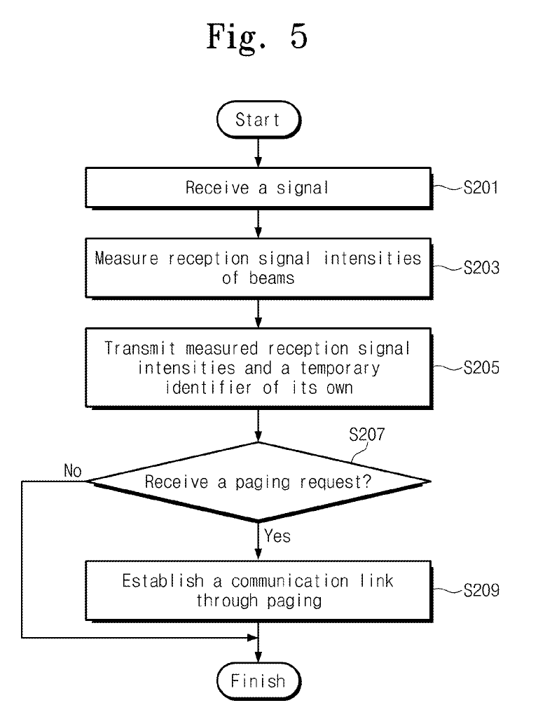

FIG. 5 is a flow chart illustrating an operation method of the peripheral device illustrated in FIG. 4.

Referring to FIG. 5, the wireless part 211 receives a signal (S201). The wireless part 211 outputs the received reception signal to the reception signal processing part 213.

The reception signal processing part 213 measures the reception signal intensities of the beams (S203). The reception signal processing part 213 measures the reception signal intensities respectively corresponding to the main beam and the side beams. The reception signal processing part 213 outputs the measured reception signal intensities to the controller 214. Additionally, the reception signal processing part 213 demodulates the cognition device identifier included in the reception signal and then the demodulated cognition device identifier to the controller 214. If the controller 214 receives the reception signal intensities, the controller 214 outputs the peripheral device identifier corresponding to the temporary identifier of its own to the transmission processing part 212.

The transmission processing part 212 transmits the measured reception signal intensities and the temporary identifier of its own to the device cognition apparatus 100 through the wireless part 211 (S205).

The controller 214 confirms whether the reception signal processing part 213 receives a paging request for paging through the wireless part 211 or not (S207). If the paging request is not received, the controller 214 finishes the operation. If the paging request is received, the controller 214 proceeds to a step S209.

The controller 214 establishes the communication link by paging with device cognition device 100 (S209). To achieve this, the controller 214 may establish the communication link with the device cognition apparatus 100 by transmission of a signal for paging response

The peripheral device 210 is described as an example with reference to FIGS. 4 and 5. However, other peripheral devices 220 and 230 may have the same structure as described in FIG. 4 and perform an operation similar to the operation illustrated in FIG. 5. Thus, the peripheral device 210 desiring the communication may be operated from the step S207 to the step S209. However, the other peripheral devices 220 and 230 may finish the operation after the step S 207.

According to embodiments of the inventive concept, the device cognition apparatus cognizes the peripheral device based on the signal intensities between the formed beams. Thus, it is possible to reduce or minimize a required time for selecting the device for establishing the communication link. Additionally, the device cognition apparatus may secure a sufficient distance from the peripheral device for searching the peripheral devices due to the beams.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A device cognition apparatus comprising:
a wireless part forming a main beam and side beams;
a transmission signal processing part pointing the main beam at a peripheral device for establishing a communication link;
a reception signal processing part receiving reception signal intensities respectively corresponding to the main beam and the side beams from each of a plurality of peripheral devices; and
a controller calculating signal differences between the main beam and the side beams based on the received reception signal intensities and selecting the peripheral device for establishing the communication link from the plurality of peripheral devices by the result of the calculation.

2. The device cognition apparatus of claim 1, wherein the reception signal processing part receives peripheral device identifiers for respectively cognizing the plurality of peripheral devices from the plurality of peripheral device.

3. The device cognition apparatus of claim 1, wherein the transmission signal processing part controls the wireless part in order that a single including an identifier information of the peripheral device for establishing the communication link is transmitted through the main beam.

4. The device cognition apparatus of claim 1, wherein the controller comprises:
a signal intensity calculation part calculating signal intensity differences between the main beam and the side beams by calculating the signal differences;
a device cognition part cognizing the peripheral device having a minimum difference between the calculated signal intensity differences as the peripheral device for establishing the communication link; and
a link establishment part establishing the communication link with the cognized peripheral device through paging.

5. The device cognition apparatus of claim 1, wherein the controller excludes a peripheral device of which the signal intensity received through the reception signal processing part is less than a predetermined critical value, from selecting the peripheral device for establishing the communication link.

6. The device cognition apparatus of claim 1, wherein the controller controls the transmission signal processing part so that the transmission signal processing part transmits a paging signal to establish the communication link by paging of the selected peripheral device.

7. The device cognition apparatus of claim 1, wherein the wireless part includes an arrangement antenna for generating the main beam and the side beams.

8. The device cognition apparatus of claim 1, wherein the transmission signal processing part transmits a signal including a cognition device identifier of the peripheral device for establishing the communication link when the wireless part forms the main beam and the side beams.

9. A method for cognizing a device using a device cognition apparatus, comprising:
forming a main beam and side beams;
receiving reception signal intensities respectively corresponding to the main beam and the side beams from each of peripheral devices;
selecting a peripheral device having the minimum difference between signal intensity differences between the main beam and the side beams; and
establishing a communication link with the selected peripheral device through paging.

10. The method of claim 9, wherein forming the main beam and the side beams comprises:
forming the main beam and the side beams toward the peripheral device desiring the communication link.

11. The method of claim 10, wherein the side beams are disposed at a left side and a right side of the main beam, respectively.

12. The method of claim 11, wherein selecting the peripheral device comprises:
calculating a first signal intensity difference between the main beam and the left side beam and a second signal intensity difference between the main beam and the right side beam of each of the peripheral devices;
calculating an absolute difference value between the first signal intensity difference and the second signal intensity difference of each of the peripheral devices; and
selecting the peripheral device having the minimum absolute difference value from the peripheral devices.
